(19) United States
(12) Patent Application Publication
(10) Pub. No.: US 2024/0238870 A1
(43) Pub. Date: Jul. 18, 2024

(54) METHOD & COMPUTER PROGRAM PRODUCT

(71) Applicant: AKTIEBOLAGET SKF, GOTEBORG (SE)

(72) Inventors: Marcus C. ANDERSSON, Molndal (SE); Marcel ESCURSELL, Goteborg (SE)

(21) Appl. No.: 18/559,808

(22) PCT Filed: May 30, 2022
(86) PCT No.: PCT/EP2022/064624

§ 371 Date: Nov. 9, 2023

(30) Foreign Application Priority Data
Jun. 2, 2021 (DE) 10 2021 205 642.3

(51) Int. Cl. B22F 3/17; B22F 3/18; B33Y 10/00

(52) U.S. Cl. CPC B22F 3/17; B22F 3/18; B22F 2003/175; B22F 2003/185; B33Y 10/00

(57) ABSTRACT

A method is for treating at least one part of a metal component that is at least partly produced by additive manufacturing. The method comprises the steps of heating the at least one part of the metal component to form at least one softened region, and applying a mechanical load to the at least one softened region to plastically deform the metal in the at least one softened region.

### TECHNICAL FIELD

The present invention concerns a method for treating at least one part of a metal component that is at least partly produced by additive manufacturing. The present invention also concerns a computer program product that comprises a computer program arranged to cause a computer or a processor to control the execution of the steps of such a method.

### BACKGROUND OF THE INVENTION

Additive manufacturing (AM), which is commonly known as 3D-printing, is the construction of a three-dimensional object from a computer aided design (CAD) model or a digital 3D model. The term can refer to a variety of processes in which material is deposited, joined or solidified under computer control to create the three-dimensional object. For example, powders may be fused together, typically layer by layer, during additive manufacturing.

A wide range of metal components, such as bearing and transmission components, are produced using additive manufacturing. There is however always a degree of porosity in metal components produced by AM methods which can, if left untreated, adversely affect the physical properties of the metal component, such as fatigue. Fatigue is the weakening of a material caused by cyclic loading that results in progressive and localized structural damage and the growth of cracks. Once a crack has been initiated, it can grow with each loading cycle and it will continue to grow until it reaches a critical size, whereupon rapid propagation and complete fracture of the component may occur.

Fatigue failure of a rolling element bearing results from progressive flaking or pitting of the surfaces and/or subsurface of the rolling elements and of the surfaces and/or subsurface of the corresponding bearing races. The flaking and pitting may cause seizure of one or more of the rolling elements, which in turn may generate excessive heat, pressure and friction, and even result in the premature failure of the rolling element bearing.

Hot Isostatic Pressing (HIP) is used to reduce the porosity and increase the density of metal components produced by additive manufacturing and thereby improves a metal component's physical properties and workability. The HIP process subjects a component to both elevated temperature and isostatic gas pressure in a high-pressure containment vessel, usually using an inert pressurizing gas, such as argon. Metal powders can be turned into compact solids using this method.

The HIP process is however a time consuming, complex and expensive process since it requires the application of high pressures (50-300 MPa) and high process soak temperatures (up to 1320° C. for nickel-based superalloys). It is also difficult to integrate into the production flow of a manufacturing process. Furthermore, HIP is not feasible for treating large metal components, such as bearing rings having a diameter greater than one metre for example, since the size of a high-pressure containment vessel limits the size of components that can be treated.

### SUMMARY OF THE INVENTION

An object of the invention is provide an improved method for treating at least one part of a metal component that is at least partly produced by additive manufacturing.

At least one of these objects is achieved by a method comprising the steps recited in claim 1. The method namely comprises the steps of heating the at least one part of the metal component, i.e. the at least one part of the metal component that has been produced by additive manufacturing, to form at least one softened region, and applying a mechanical load to the at least one softened region, i.e. to the same region that has just been heated, to plastically deform the metal in the at least one softened region. During the method, at least one part of the metal component is thereby temporarily and locally softened by a controllable heating device, and a mechanical load is then immediately applied to the softened region.

The application of the heat and mechanical load reduces or eliminates internal voids, cracks and porosity in the at least one part of the metal component that has been produced by additive manufacturing through a combination of plastic deformation, creep and diffusion bonding. The metal grains subjected to the method are refined and high compressive stresses are generated within the metal component, which results in an improved microstructure, better surface finish, and improved physical properties, such as improved fatigue resistance. The method according to the present invention is not only less costly and less complex than the HIP process, but there is no restriction as regards the size of metal components that may be treated using the method.

It should be noted that the term “at least one part of a metal component that is at least partly produced by additive manufacturing” is intended to mean that either 100% of the metal component has been produced by additive manufacturing, or only one or more parts of the metal component have been produced by additive manufacturing. Furthermore, the expression is not only intended to include the manufacture of a new metal component or a new metal component part by additive manufacturing, but it also includes the re-manufacture of a metal component or a metal component part by removing and/or adding material from one or more damaged or worn areas of a metal component or a metal component part by additive manufacturing.

According to an embodiment of the invention the step of heating the at least one part of the metal component is carried out using a laser, such as a focused laser beam, or an induction heater. Any suitable heating means may however be used.

According to an embodiment of the invention the at least one part of the metal component is at least one part that is produced by laser cladding using laser cladding equipment, and the method comprises the step of heating the at least one laser cladded part of the metal component using a laser of the laser cladding equipment. Both the production and treatment of at least one part of a metal component is thereby be carried out using the same equipment, which reduces the cost and complexity of the production and post-production process. Laser cladding is a surface welding method that enables metallurgical bonding with a base material substrate. A high energy laser beam creates an intense heat input and then metals or metal alloys are bonded to the surface of the base material substrate with a low degree of dilution. For example, a bearing ring may comprise a forged base ring with laser cladded raceways bonded thereto. Laser cladding is also called “Directed Energy Deposition” and “Laser Metal Deposition”.

According to an embodiment of the invention the step of heating the at least one part of the metal component comprises heating the at least one part of the metal component to at least the forging temperature of the metal in the at least one part of the metal component, or a to a temperature that is 50-150° C. lower than the melting point of the metal in the at least one part of the metal component. The forging temperature is the temperature at which a metal becomes substantially more soft. Bringing a metal to its forging temperature allows the metal's shape to be changed by applying a relatively small force, without creating cracks. For most metals, the forging temperature is approximately 70% of the metal's melting temperature.

According to an embodiment of the invention the mechanical load has a magnitude greater than the yield strength of the metal in the at least one softened region. A mechanical load may be applied with any suitable mechanical load-applying device, such as by means of a rolling ball, a roller or a hammer.

According to an embodiment of the invention the method comprises the steps of stopping the heating step, and applying the mechanical load to the at least one softened region of the metal component within 0.10 second after stopping the heating step. A mechanical load is preferably applied as soon as the heating step stops, or as soon as possible after a softened region has been formed so that the metal in the softened region will not start to cool down, or cool down too much, before the mechanical load is applied. Once the heating has stopped, a mechanical load may for example be applied to a softened region of a metal component within 0.05 second, or preferably within 0.01 second after stopping the heating step.

According to an embodiment of the invention the step of heating the at least one part of the metal component comprises heating the at least one part of the metal component so that the softened region extends to a maximum depth of 4 mm from a surface of the metal component. The method according to the present invention may thereby be used to provide only a surface layer having improved physical properties rather than treating a whole metal component. The surface layer may extend to a depth of 0.2 to 3 mm from a surface of the metal component in the final treated product. The depth of such a surface layer may be chosen depending on the metal component size or application in which the metal component is to be used. However, the method according to the present invention may also be used to treat a whole metal component rather than just a surface layer of the metal component.

According to an embodiment of the invention the method comprises the step of moving the metal component, such as by rotating the metal component, to subject the at least one part of the metal component to the method.

According to an embodiment of the invention the method is carried out using a heating device and a mechanical load-applying device which are independently moveable.

Alternatively, the method may be carried out using a single tool that comprises both a heating device and a mechanical load-applying device, whereby the heating device and the mechanical load-applying device are arranged to move together and maintain the same relative position during the method.

According to an embodiment of the invention the method comprises the step of moving the heating device and the mechanical load-applying device, or the single tool, to subject the at least one part of the metal component to the method.

According to an embodiment of the invention the method comprises the step of mounting the heating device and/or the mechanical load-applying device, or the single tool, on a robot or a computer numerical control (CNC) machine.

According to an embodiment of the invention the method is carried out during an additive manufacturing process to treat at least one part of metal component that has already been produced by the additive manufacturing process, and before at least one further part of the metal component is produced by the additive manufacturing process. It should be noted that such a method may be used to treat an entire metal component, one layer at a time for example. Alternatively, such a method may be used to provide a metal component with a plastically deformed and densified layer or part that is located at a distance below an outer surface of the final product rather than at a surface of the final product. A metal component having a complex shape or geometry or including one or more hollow parts may therefore be at least partly produced by additive manufacturing and then provided with one or more plastically deformed and densified layers or parts of any size and shape, which may be located at any desired location within the metal component.

According to an embodiment of the invention the metal component is one of the following: a bearing component, such as an inner or outer bearing ring, a bearing raceway, a transmission component, such as a sprocket, a gear, a bushing, a hub, a coupling, a bolt, a screw, a shaft, such as a spindle shaft, a roller or roller mantle, a seal, a tool, or any other component for an application in which it is subjected to alternating Hertzian stresses.

The present invention also concerns a computer program product that comprises a computer program containing computer program code means arranged to cause a computer or a processor to control the execution of the steps of a method according to any of the embodiments of the invention, stored on a computer-readable medium or a carrier wave.

### BRIEF DESCRIPTION OF THE DRAWINGS

The present invention will hereinafter be further explained by means of non-limiting examples with reference to the appended schematic figures where;

FIG. 1 shows a metal component that can be treated using a method according to an embodiment of the invention,

FIG. 2 shows a method according to an embodiment of the invention, and

FIG. 3 is a flow chart showing the essential steps of a method according to an embodiment of the invention.

It should be noted that the drawings have not necessarily been drawn to scale and that the dimensions of certain features may have been exaggerated for the sake of clarity.

### DETAILED DESCRIPTION OF EMBODIMENTS

FIG. 1 shows a steel rolling element bearing 10, at least one part of which may be treated using a method according to an embodiment of the invention.

A metal component as described in this document may comprise or be made of any pure metal, such as iron, nickel, titanium, copper, aluminium, tin or zinc, or any metal alloy, such as steel, carbon steel, stainless steel, a nickel-based superalloy, a titanium alloy, brass or bronze. It may be a ball bearing, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a slewing bearing or a ball screw.

The illustrated rolling element bearing 10 may range in size from 10 mm diameter to a few metres in diameter and have a load-carrying capacity from a few tens of grams to many thousands of tonnes. A metal component 10 as described in this document may namely be of any size and have any load-carrying capacity. The rolling element bearing 10 has an inner ring 12 and an outer ring 14 and a set of rolling elements 16. The inner ring 12 and the outer ring 14 have been produced entirely by additive manufacturing and may therefore be considered to be metal components that have been entirely produced by additive manufacturing, or they may be considered to be parts of a metal component, such as the rolling element bearing 10, which may also comprise one or more components that have not been produced by additive manufacturing.

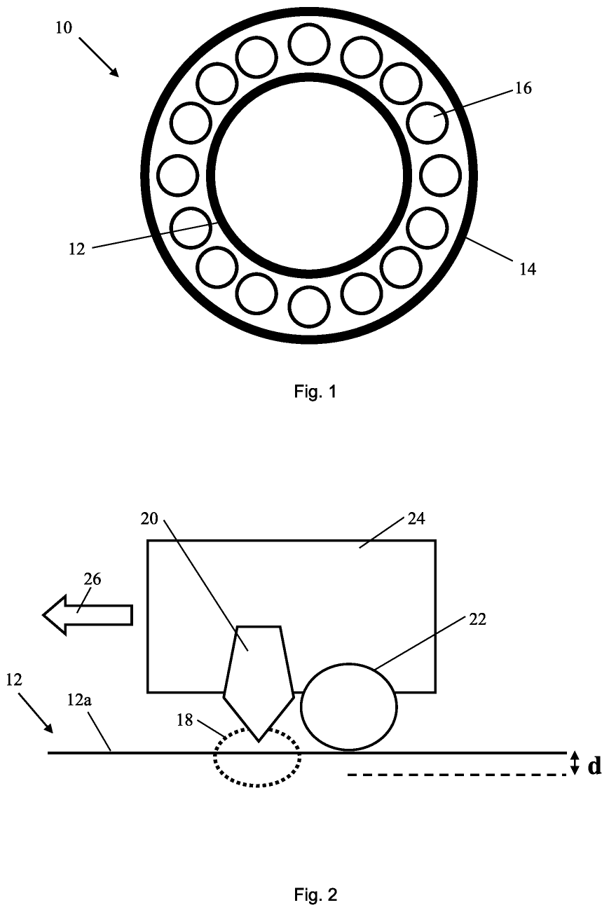

FIG. 2 schematically shows an outer surface 12a of an inner ring 12 that has been produced by additive manufacturing being subjected to a method according to the present invention. The method comprises the steps of locally heating the outer surface 12a of the inner ring 12, using a laser cladding laser for example, to form at least one softened region 18 that extends at least to a depth, d, below the surface 12a of the inner ring 12, where the depth, d, is the desired depth of the surface layer in the final treated product. The heating step may be carried out using one or more heating devices 20.

A softened region 18 may extend to a maximum depth of 4 mm, or to a maximum depth of 3 mm, or to a maximum depth of 2 mm from a surface of the metal component. It should be noted that a softened region 18 may however be located at a distance from the outer surface of the final metal component product, or extend through the entire thickness of a metal component 10. A plastically deformed and densified surface layer or inner layer may for example have a minimum thickness of 0.1 mm, or 0.2 mm, or 0.3 mm or 0.4 mm or 0.5 mm. A final metal component product may comprise a plurality of plastically deformed and densified surface layers and/or inner layers by carried out the method according to the present invention both during and after laser cladding.

A metal component may be heated to a temperature of 1100-1400° C., such as up to a temperature of 1200° C., up to 1300° C. or up to 1400° C. The heating step should be continued until a desired or predetermined temperature has been reached throughout or in part of the softened region 18. The temperature of a softened region may be determined by calculation or measurement, using a temperature sensor for example.

Once a softened region 18 has been formed, the method comprises the step of stopping the heating step and applying a localized mechanical load using a mechanical load-applying device 22 to the at least one softened region 18 to plastically deform the metal in the at least one softened region 18. Any suitable contact tool, such as a rolling ball, a roller or hammer may be used to apply the mechanical load. The mechanical load has a magnitude that is greater than the yield strength of the metal in the softened region 18. The applied mechanical load may for example be 10%, 20%, 30%, 40% or 50% higher than the yield strength of the metal in the softened region 18.

A heating step may be considered to have stopped as soon as a heating source is moved away from a softened region 18, or as soon as the temperature of a softened region 18 is no longer increasing, or as soon as a predetermined temperature has been reached in one or more parts of a metal component 10 or softened region 18.

The method according to the present invention may comprise the step of moving a metal component 10, for example rotating an inner ring 12 at a constant speed, so as to subject at least one part of the metal component 10 to the method. A metal component 10 may be moved so that its entire outer surface is subjected to a method according to the present invention.

In the illustrated embodiment, the heating device 20 and the mechanical load-applying device 22 are provided in a single tool 24, whereby the heating device 20 and the mechanical load-applying device 22 are arranged to move together and maintain the same relative position during the method. The single tool 24 may be mounted on a robot or a computer numerical control (CNC) machine which is arranged to move the single tool 24 in a way that results in at least one part of metal component 10 being subjected to a method according to the present invention. For example, the single tool 24 may be arranged to pass over the outer surface 12a of the inner ring 12 in the direction of the arrow 26 in FIG. 2, whereby the heating device 20 is arranged to pass over a part of the outer surface 12a of the inner ring 12 before the mechanical load-applying device 22.

The mechanical load-applying device 22 may be mounted at a fixed distance, such as 1 mm, from the heating device 20 to ensure that a mechanical load will be applied to a softened region 18 as quickly as possible once the heating device 20 is moved in the direction of the arrow 26 in FIG. 2. As the single tool 24 passes over the outer surface 12a of the inner ring 12 it plastifies and densifies the metal near the outer surface 12a. The effect of the method is therefore similar to the effect of hot rolling.

Alternatively, the method according to the present invention may be carried out using a heating device 20 and a mechanical load-applying device 22 which are independently moveable, one or both of which may be mounted on a robot or a CNC machine, whereby the robot or CNC machine process the metal component 10 to meet specifications by following a coded programmed instruction and without a manual operator directly controlling the treatment method.

Once the illustrated inner ring 12 has been subjected to a method according to the present invention it will have a surface layer having a depth, d, with an improved microstructure in which internal voids, cracks and porosity have been eliminated or reduced. The inner ring 12 will consequently exhibit improved physical properties, such as improved fatigue resistance. Plastically deformed and densified surface layers may for example be used to improve the physical properties of the parts of bearing rings constituting raceways that will come into contact with rolling elements when the bearing rings are in use.

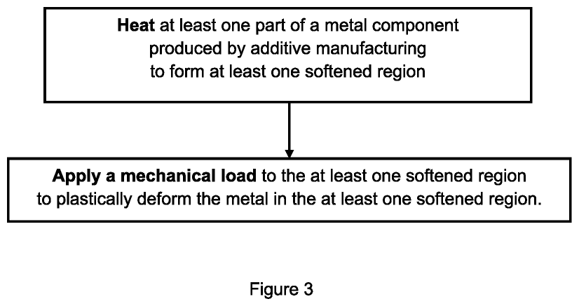

FIG. 3 is a flow chart showing the essential steps of the method according to the present invention. The step of applying a mechanical load is carried out after the heating step. However, the step of applying a mechanical load is ideally carried out at the same time as the heating step if such simultaneous heating and mechanical load application is possible.

A computer program may be used to cause a computer or a processor to control the execution of the steps of a method according to any of the embodiments of the method.

Further modifications of the invention within the scope of the claims would be apparent to a skilled person.

1. A method for treating at least one part of a metal component that is at least partly produced by additive manufacturing, the method comprising the steps of:
heating the at least one part of the metal component to form at least one softened region, and
applying a mechanical load to the at least one softened region to plastically deform the metal in the at least one softened region.

2. The method according to claim 1, wherein:
the step of heating the at least one part of the metal component is carried out using a laser or an induction heater, or
the at least one part of the metal component is produced by laser cladding using laser cladding equipment and the step of heating the at least one part of the metal component includes using a laser of the laser cladding equipment.

3. The method according to claim 1, wherein the step of heating the at least one part of the metal component includes heating the at least one part of the metal component to at least the forging temperature of a metal in the at least one part of the metal component or to a temperature that is 50-150° C. lower than the melting point of the metal in the at least one part of the metal component.

4. The method according to claim 1, further comprising the steps of:
stopping the heating step, and
applying the mechanical load to the at least one softened region of the metal component within 0.10 second after stopping the heating step.

5. The method according to claim 1, wherein the step of heating the at least one part of the metal component includes heating the at least one part of the metal component so that the softened region extends to a maximum depth of 4 mm from a surface of the metal component.

6. The method according to claim 1, further comprising a step of moving the metal component to subject the at least one part of the metal component to the steps of heating and applying the mechanical load.

7. The method according to claim 1, wherein at least one of:
the step of heating the at least one part of the metal component is carried out using a heating device and the step of applying the mechanical load is carried out using a mechanical load-applying device which is moveable independently of the heating device,
the steps of heating the at least one part of the metal component and applying the mechanical load are carried out using a single tool that includes both a heating device and a mechanical load-applying device, whereby the heating device and the mechanical load-applying device are arranged to move together and maintain the same relative position during the steps of heating and applying the mechanical load, and
the method further comprises a step of moving a heating device and a mechanical load-applying device or a single tool to subject the at least one part of the metal component to the steps of heating and applying the mechanical load.

8. The method according to claim 7, further comprising a step of mounting the heating device and/or the mechanical load-applying device, or the single tool, on a robot or a computer numerical control (CNC) machine.

9. The method according to claim 1, wherein the steps of heating the at least one part of the metal component and applying the mechanical load to the at least one softened region of the metal component are carried out during an additive manufacturing process to treat the at least one part of the metal component produced by the additive manufacturing process and before at least one further part of the metal component is produced by the additive manufacturing process.

10. A computer program product comprising a computer program containing computer program code arranged to cause a computer or a processor to control the execution of the steps of a method according to claim 1, the computer program being stored on a computer-readable medium or a carrier wave.

11. The method according to claim 6, wherein the step of moving the metal component includes rotating the metal component during the steps of heating the at least one part of the metal component and applying the mechanical load to the at least one softened region of the metal component.
